(19) United States
(12) Patent Application Publication
(10) Pub. No.: US 2013/0171860 A1
(43) Pub. Date: Jul. 4, 2013

(54) CONNECTOR MOUNTING APPARATUS

(71) Applicants: Hong Fu Jin Precision Industry (WuHan) Co., Ltd., Wuhan (CN); Hon Hai Precision Industry Co., Ltd., New Taipei (TW)

(72) Inventors: CHUNG CHAI, New Taipei (TW); DA-LONG SUN, Wuhan (CN); SHENG-HE LI, Wuhan (CN); WEI-YONG MA, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/685,625

(22) Filed: Nov. 26, 2012

(30) Foreign Application Priority Data
Dec. 30, 2011 (CN) 201110453242.2

(51) Int. Cl. H01R 13/516

(52) U.S. Cl. CPC H01R 13/516
USPC 439/358

(57) ABSTRACT

A connector mounting apparatus includes a receiving bracket for receiving a connector, and a front panel. The receiving bracket includes two hooks and a positioning tab. The front panel includes a front panel body. The front panel body defines two securing holes and a positioning cutout. The two securing holes are engaged by the two hooks to prevent the receiving bracket from moving along a first direction. The front panel includes a resilient arm. The positioning tab is received in the positioning cutout. The resilient arm is adjacent to the positioning cutout to prevent the positioning tab from moving along a second direction. The resilient arm is pressed to enable the positioning tab to be moved out of the positioning cutout along the second direction. The two hooks disengage from the two securing holes when the two hooks move along the second direction.

### BACKGROUND

1. Technical Field

The disclosure generally relates to connector mounting apparatuses, especially, to a connector mounting apparatus mounted to a front panel of a computer.

2. Description of Related Art

There are a plurality of connectors mounted in a front panel of a computer for connecting to peripheral devices. The connectors are mounted to the front panel via screws. However, it is a waste of time to mount the connectors to the front panel.

Thus, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector mounting apparatus.

FIG. 2 is an isometric view of a front panel of FIG. 1.

FIG. 3 is an assembled view of FIG. 1.

FIG. 4 is similar to FIG. 3, but viewed from another aspect

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

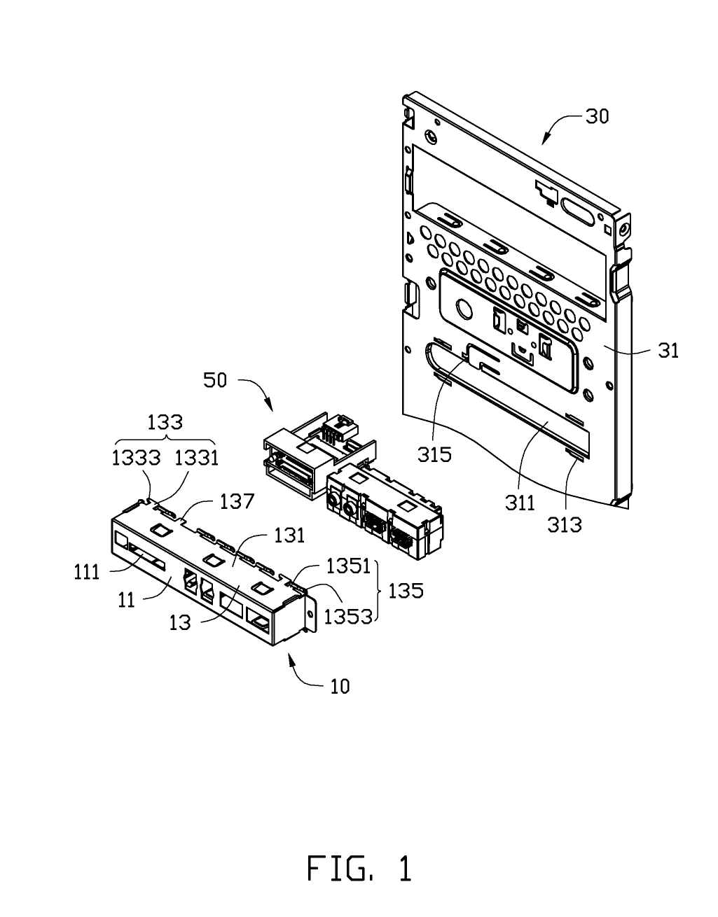

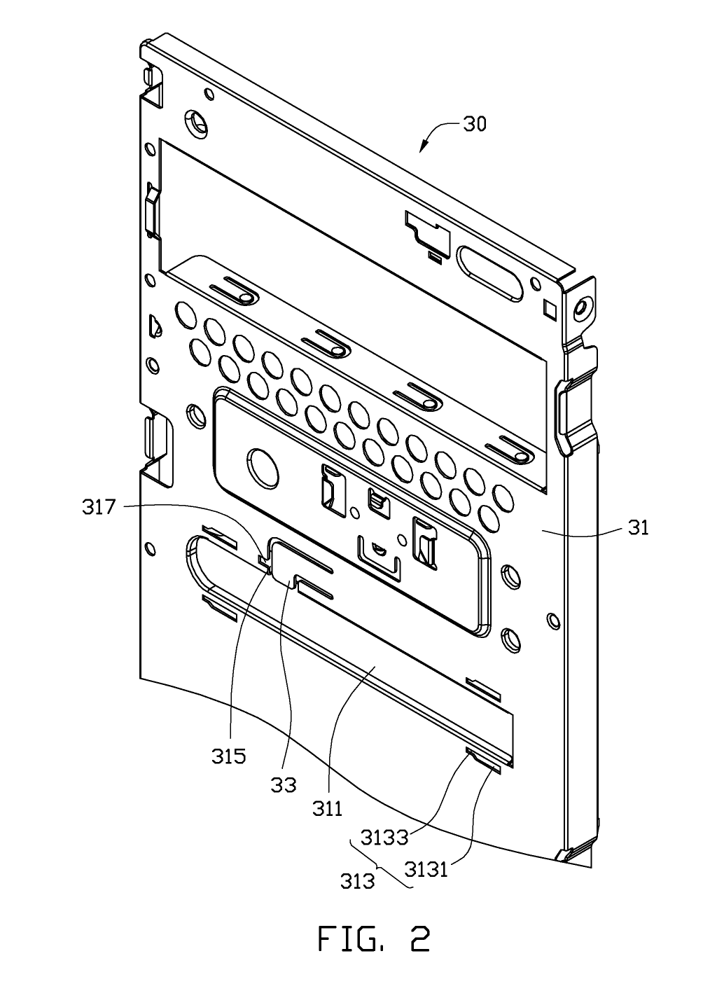

FIGS. 1 and 2 show one embodiment of a connector mounting apparatus. The connector mounting apparatus includes a receiving bracket 10 and a front panel 30. The receiving bracket 10 is used for securing a plurality of connectors 50 to the front panel 30.

The receiving bracket 10 includes a front wall 11 and two mounting walls 13, extending from opposite sides of the front wall 11. The front wall 11 defines a plurality of mounting holes 111 corresponding to the connectors 50. Each mounting wall 13 includes a mounting wall body 131, two hooks 133 extending from the mounting wall body 131, and a plurality of elastic tabs 135 extending from the mounting wall body 131. The hook 133 is L-shaped. The hook 133 includes a connecting portion 1331 extending from the mounting wall body 131 and an engaging portion 1333 extending from the connecting portion 1331. The elastic tab 135 includes an extending portion 1351, extending from the mounting wall body 131, and an elastic resisting portion 1353, extending from the extending portion 1351. One of the two mounting walls 13 further includes a positioning tab 137 extending from the mounting wall body 131.

The front panel 30 includes a front panel body 31 and a resilient arm 33 extending from the front panel body 31. In one embodiment, the resilient arm 33 is formed by punching. The front panel body 31 defines a mounting opening 311, corresponding to the receiving bracket 10, and four securing holes 313, corresponding to the hooks 133. The securing hole 313 includes a wide part 3131 and a narrow part 3133 communicating with the wide part 3131. The front panel body 31 further defines a receiving opening 315 and a positioning cutout 317 for receiving the positioning tab 137. The positioning cutout 317 communicates with the receiving opening 315. The resilient arm 33 extends from an edge of the receiving opening 315 and is located in the receiving opening 315.

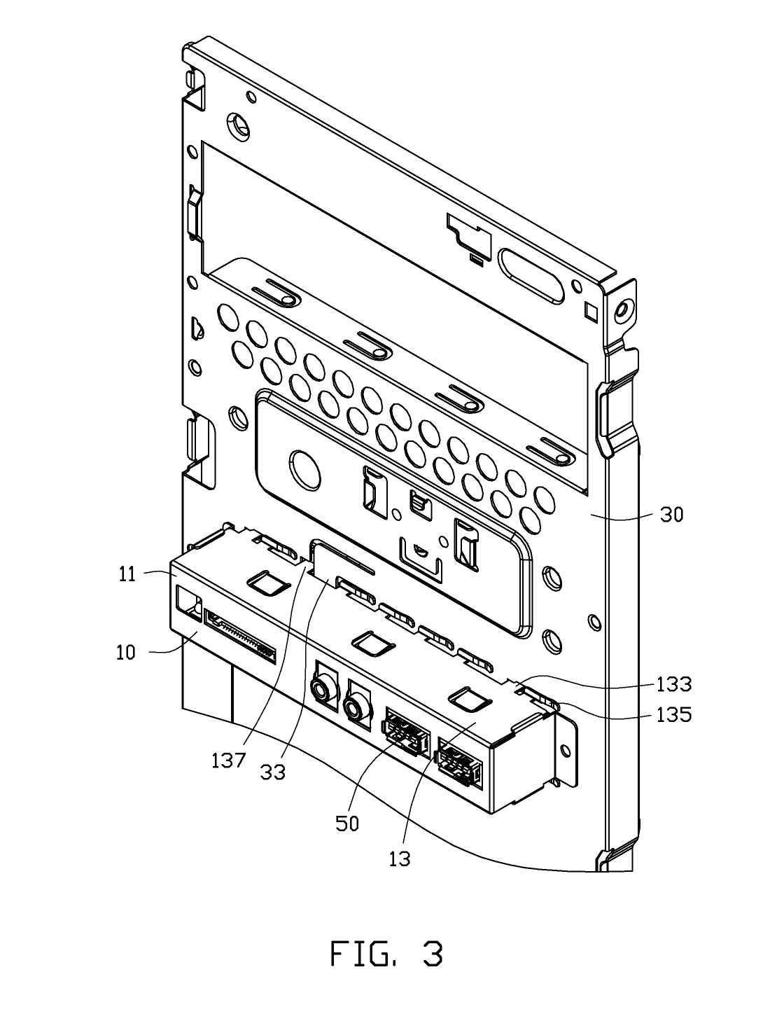

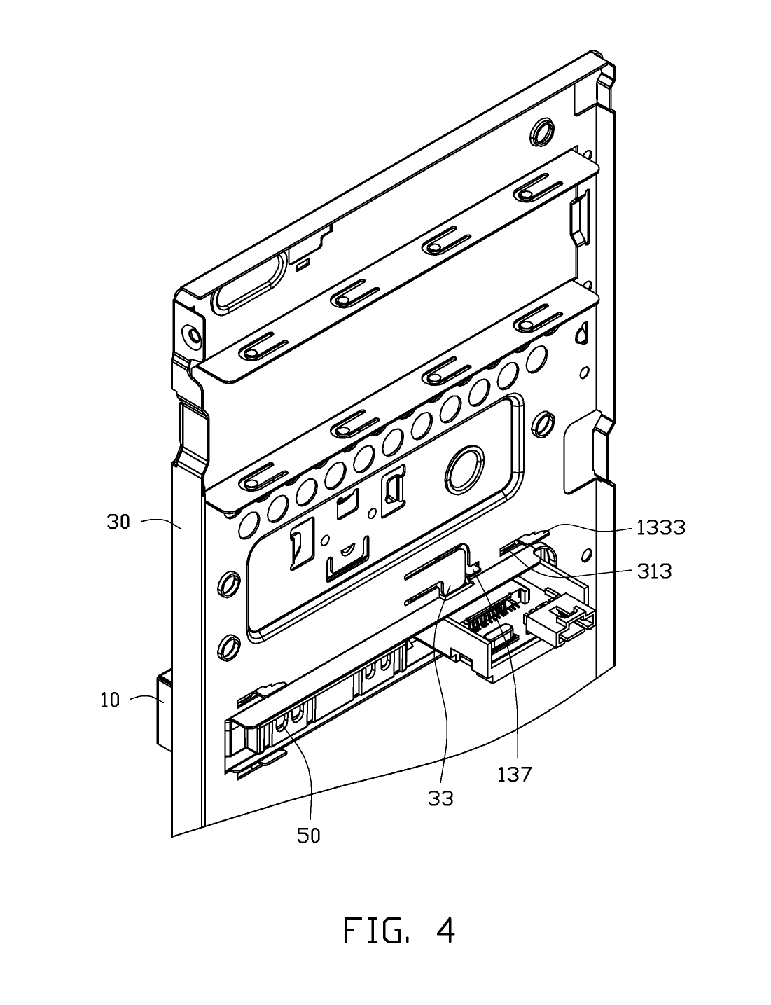

FIGS. 3 and 4 show that in assembly, the connectors 50 are received in the receiving bracket 10 to enable each connector 50 to be aligned with one mounting hole 111. At this time, the connectors 50 are located between the two mounting walls 13. The receiving bracket 10 is aligned with the mounting opening 311 of the front panel 30 to enable the hooks 133 to correspond to the securing holes 313. At this time, the positioning tab 137 corresponds to the resilient arm 33. The receiving bracket 10 moves towards the front panel 30 to enable the connectors 50 to pass through the mounting opening 311. The hooks 133 of the receiving bracket 10 pass through the wide parts 3131 of the securing holes 313. At this time, the positioning tab 137 is located in the receiving opening 315 and resists the resilient arm 33, to enable the resilient arm 33 to be deformed. The receiving bracket 10 moves along a first direction, substantially parallel to the front panel body 31, to enable the hooks 133, of the receiving bracket 10, to move to the narrow parts 3133, of the securing holes 313, from the wide parts 3131. The resilient arm 33 rebounds to be received in the receiving opening 315 to prevent the receiving bracket 10 from moving along a second direction that is substantially opposite to the first direction. At this time, the hooks 133 are located in the narrow parts 3133 of the securing holes 313. The mounting wall body 131 and the engaging portion 1333 of the hook 133 are located on opposite sides of the front panel body 31 to prevent the receiving bracket 10 from moving along a direction substantially perpendicular to the front panel body 31. The elastic resisting portion 1353 of the elastic tabs 135 of the receiving bracket 10 resiliently resist the front panel body 31.

In disassembly, the resilient arm 33 is pushed inward to deform. The receiving bracket 10 moves along the second direction to enable the positioning tab 137, to move from the positioning cutout 317 to the receiving opening 315 and resist the resilient arm 33. The hooks 133 move from the narrow parts 3133 to the wide parts 3131. The receiving bracket 10 is thus easily removed out of the front panel 30.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A connector mounting apparatus, comprising:
a receiving bracket for receiving a connector, the receiving bracket comprises two hooks and a positioning tab; and
a front panel, the front panel comprises a front panel body; the front panel body defines two securing holes engaged by the two hooks, a receiving opening, and a positioning cutout communicating with the receiving opening; and the front panel further comprises a resilient arm extending from an edge of the receiving opening;
wherein the resilient arm extends in the receiving opening; the two hooks are configured to pass through the two securing holes and move along a first direction, which is substantially parallel to the front panel body, to engage the two securing holes, thereby preventing the receiving bracket from moving along a second direction that is substantially perpendicular to the front panel body; the resilient arm is configured to be deformed when the positioning tab resists the resilient arm; and the resilient arm is further configured to rebound to prevent the positioning tab from moving a third direction, which is substantially opposite to the first direction, when the positioning tab is located in the positioning cutout.

2. The connector mounting apparatus of claim 1, wherein the receiving bracket comprises two mounting walls substantially parallel to each other; the two mounting walls are configured to receive the connector therebetween; each of the two mounting walls comprises a mounting wall body; and the two hooks extend from the two mounting walls.

3. The connector mounting apparatus of claim 2, wherein the two hooks are L-shaped.

4. The connector mounting apparatus of claim 2, wherein each of the two hooks comprises a connecting portion, extending from the mounting wall body of one of the two mounting walls, and an engaging portion extending from the connecting portion.

5. The connector mounting apparatus of claim 2, wherein the positioning tab extends from one of the two mounting wall bodies.

6. The connector mounting apparatus of claim 2, wherein the receiving bracket further comprises a front wall connected between the two mounting walls, and the front wall defines a mounting hole for corresponding to the connector.

7. The connector mounting apparatus of claim 1, wherein each of the two securing holes defines a wide part and a narrow part communicating with the wide part, and each of the two hooks is configured to move along the first direction from the wide part to the narrow part.

8. The connector mounting apparatus of claim 1, wherein the front panel body defines a mounting opening corresponding to the receiving bracket.

9. The connector mounting apparatus of claim 1, wherein the receiving bracket further comprises an elastic tab, and the elastic tab is configured to resiliently resist the front panel body.

10. A connector mounting apparatus, comprising:
a receiving bracket for receiving a connector, the receiving bracket comprises two hooks and a positioning tab; and
a front panel, the front panel comprises a front panel body, the front panel body defines two securing holes and a positioning cutout; the two securing holes engage the two hooks to prevent the receiving bracket from moving along a first direction that is substantially perpendicular to the front panel body; the front panel further comprises a resilient arm extending from the front panel body; the positioning tab is received in the positioning cutout; the resilient arm is adjacent to the positioning cutout, to prevent the positioning tab from moving along a second direction that is substantially parallel to the front panel body; the resilient arm is configured to be pressed to be deformed to enable the positioning tab to be capable of moving out of the positioning cutout along the second direction; and the two hooks are configured to disengage from the two securing holes when the two hooks moves along the second direction.

11. The connector mounting apparatus of claim 10, wherein the receiving bracket comprises two mounting walls substantially parallel to each other; the two mounting walls are configured to receive the connector therebetween; each of the two mounting walls comprises a mounting wall body; and the two hooks extend from the two mounting walls.

12. The connector mounting apparatus of claim 11, wherein the two hooks are L-shaped.

13. The connector mounting apparatus of claim 11, wherein each of the two hooks comprises a connecting portion extending from the mounting wall body of one of the two mounting walls and an engaging portion extending from the connecting portion.

14. The connector mounting apparatus of claim 11, wherein the positioning tab extends from one of the two mounting wall bodies.

15. The connector mounting apparatus of claim 11, wherein the receiving bracket further comprises a front wall connected between the two mounting walls, and the front wall defines a mounting hole for corresponding to the connector.

16. The connector mounting apparatus of claim 10, wherein each of the two securing holes defines a wide part and a narrow part that communicates with the wide part, and each of the two hooks is configured to move, along a third direction that is substantially opposite to the second direction, from the wide part to the narrow part.

17. The connector mounting apparatus of claim 10, wherein the front panel body defines a mounting opening corresponding to the receiving bracket.

18. The connector mounting apparatus of claim 10, wherein the receiving bracket further comprises an elastic tab, and the elastic tab is configured to resiliently resist the front panel body.
